(19) United States
(12) Patent Application Publication
(10) Pub. No.: US 2025/0336180 A1
(43) Pub. Date: Oct. 30, 2025

(54) DYNAMIC CLASSIFICATION FOR AUTONOMOUS DRIVING

(71) Applicant: AUTOBRAINS TECHNOLOGIES LTD, Tel Aviv-Yafo (IL)

(72) Inventor: Shahar Dickstein, Tel Aviv (IL)

(73) Assignee: AUTOBRAINS TECHNOLOGIES LTD, Tel Aviv-Yafo (IL)

(21) Appl. No.: 18/651,522

(22) Filed: Apr. 30, 2024

(51) Int. Cl. G06V 10/764; G06V 10/762; G06V 10/774; G06V 10/82; G06V 20/56

(52) U.S. Cl. CPC G06V 10/764; G06V 10/762; G06V 10/774; G06V 10/82; G06V 20/56

(57) ABSTRACT

A method for dynamic classification for autonomous driving, the method includes (i) producing, by a classification neural network associated with a driving of a vehicle, a catalog sample representative vector representing a catalog sample of a new class for autonomous driving being unidentified by the classification neural network at the time of the driving; (ii) generating, by the classification neural network, a new image-based representative vector representing an image of an entity of the new class; and (iii) classifying, by a classification unit that is associated with the classification neural network, the entity as being associated with the new class.

### BACKGROUND

Assisted and autonomous driving systems are known in the art. In such systems, computer implemented systems control (at least to some extent) some, or all, of a vehicle's driving functions, e.g., speed, telemetry, braking, etc. The vehicle is typically equipped with one or more sensors to provide the system with current information regarding the driving environment. The current information for the driving environment is typically used by the driving system to determine how to drive on roadways.

One of the major tasks related to driving is classifying.

There is a growing need to provide efficient classification systems and methods.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1A illustrates an example of a system;

FIG. 1B illustrates an example of a system;

FIG. 1C illustrates an example of a system;

FIG. 1D illustrates an example of a system;

FIG. 2A is an example of a method;

FIG. 2B is an example of a method;

FIG. 3 illustrates an example of representative vectors;

FIG. 4 is an example of a system; and

FIGS. 5 and 6 illustrate examples of catalog samples.

### DETAILED DESCRIPTION

There is provided a method, a system and a computer readable medium that are adaptable and are configured to identify new classes based on catalog samples.

A catalog sample is a diagram of an item or a graphical illustration of an item that differs from an actual image of the element. The graphical illustration can be stylized, abstract, or imaginative, can be a sketch or may differ from a sketch, can be generated using artificial intelligence or be generated without using artificial intelligence.

Non-limiting examples of a catalog sample include a graphical illustration of a new road sign, a road sign indicative than a certain new item should appear along the road, and the like.

The identifying may be executed without retraining a classification neural network that is trained to identify existing classes.

The classes are related to representative vectors that are learnt during a zero shot learning or a few shot learning. Any reference to one shot learning is applied mutatis mutandis to a few shot learning.

A representative vector represents an element selected of an object or a road scenario. The element was captured by a sensed information unit. The representative vector may be generated based on a cropped sensed information unit.

The different figures illustrates examples of units and/or software and/or information items and/or steps and/or components. These examples are provided for brevity of explanation. At least one of the units and/or software and/or information items and/or steps and/or components is optional or mandatory.

Any reference to a classification neural network should be applied mutatis mutandis to a classification neural network software.

Any reference to a classification unit and/or to a neural network should be applied mutatis mutandis to a classification software.

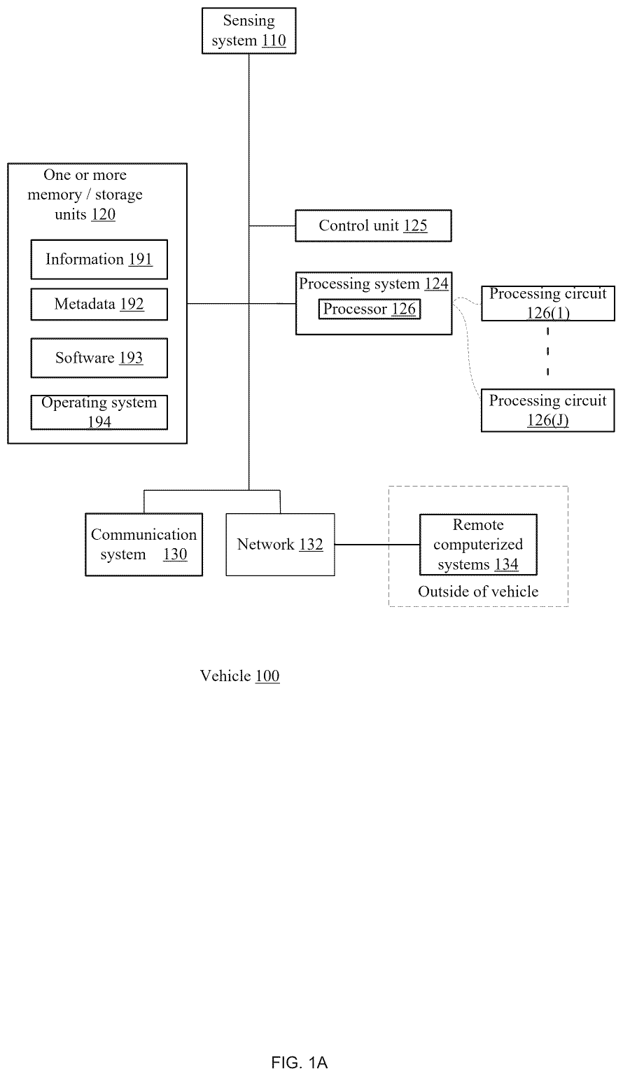

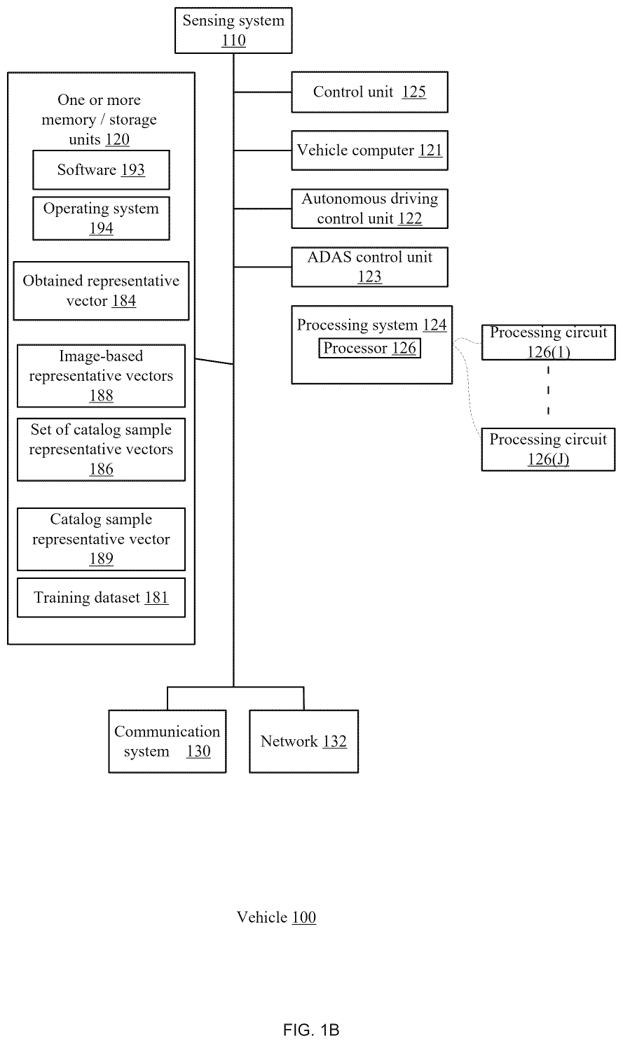

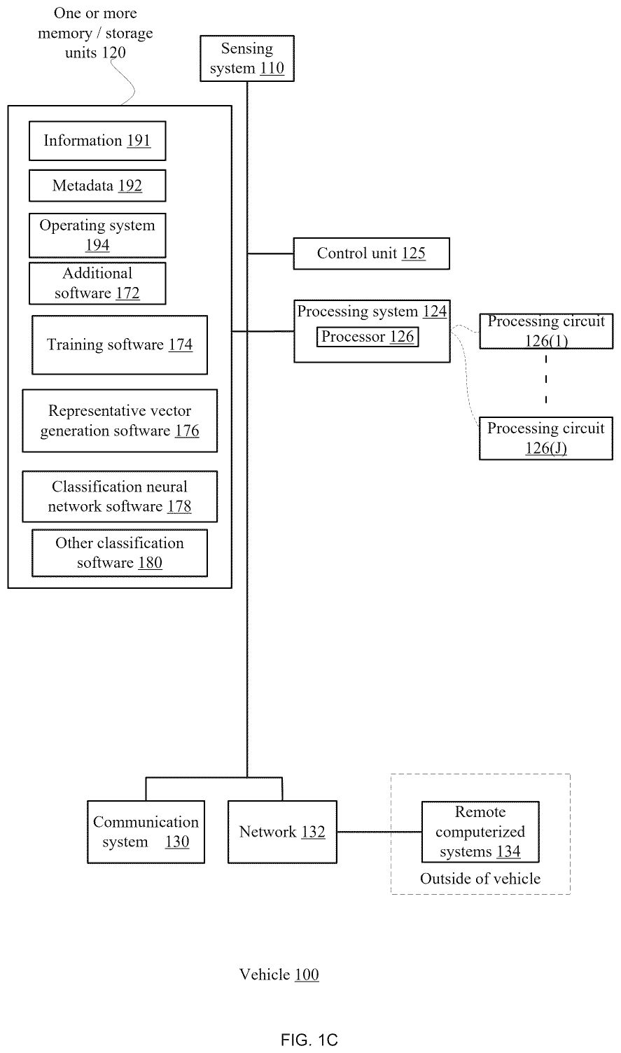

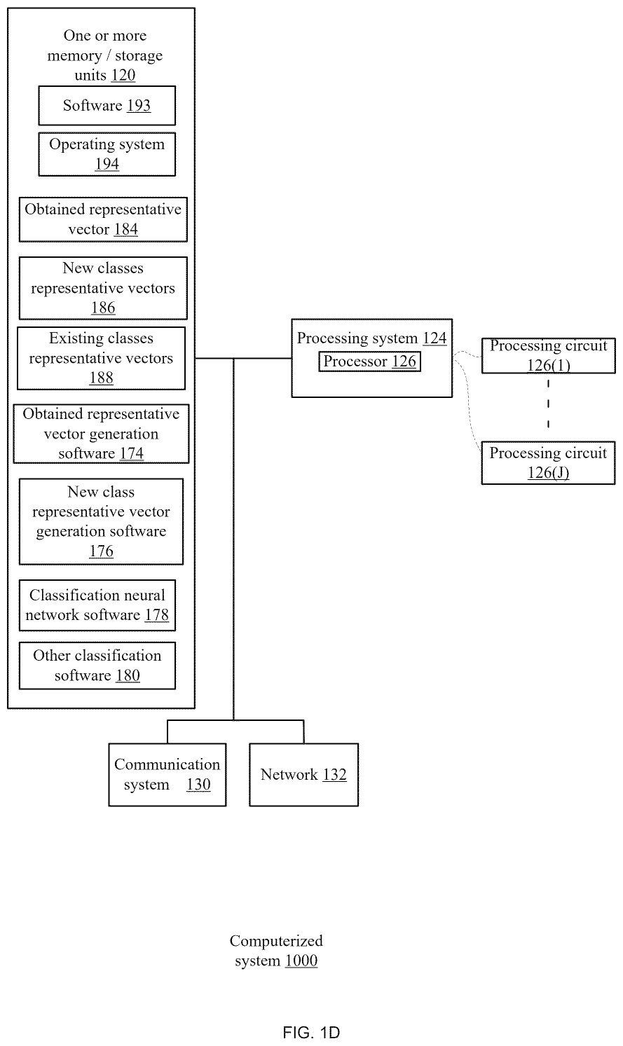

FIG. 1A illustrates an example of a vehicle 100, a network 123 and remote computerized systems 134.

The vehicle 100 includes (a) sensing system 110, a communication system 130, one or more memory and/or storage units 120, and additional units that include control unit 125, advanced driver assistance system (ADAS) control unit 123, autonomous driving control unit 122, processing system 124 including processor 126. Network 123 is in communication with the vehicle and with the remote computerized systems 134 such as servers, cloud computers, and the like.

Communication system 130, one or more memory and/or storage units 120, and processing system 134 may form a computerized system. The computerized system may include one or more other systems and/or units such as sensing system 110

The communication system 130 is configured to enable communication between the one or more memory and/or storage units 120 and/or the sensing system 110 and/or any one of the additional units and/or the network 132 (that is in communication with the remote computerized systems).

The control unit 125 is configured to control various operations related to the vehicle—such as but not limited to various steps of method 200.

The one or more memory and/or storage units 120 are illustrated as storing an operating system 194, software 193 (especially software required to execute method 201), information 191 and metadata 192 (especially information and metadata required to execute method 201). The information may include environmental information. The metadata may include any metric or an outcome of processed information—especially related to the execution of method 201.

FIG. 1B and FIG. 1C differ from FIG. 1A by including additional units such as ADAS control unit 123, autonomous driving control unit 123, and vehicle computer 123.

FIG. 1B and FIG. 1C differ from FIG. 1A by including more examples of content stored in the one or more memory and/or storage units 120.

The sensing system 110 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 110 is configured to output one or more sensed information units (SIUs).

The communication system 130 is configured to enable communication between the one or more memory and/or storage units 120 and/or the sensing system 110 and/or any one of the additional units and/or the network 132 (that is in communication with the remote computerized systems).

The controller 125 is configured to control the operation of the sensing system 110, and/or the one or more memory and/or storage units 120 and/or the one or more additional units (except the controller).

The ADAS control unit 123 is configured to control ADAS operations.

The autonomous driving control unit 122 is configured to control autonomous driving of the autonomous vehicle.

The vehicle computer 121 is configured to control the operation of the vehicle—especially controlling the engine, the transmission, and any other vehicle system or component.

The processing system 124 may include processor 146 and one or more other processors and is configured to execute any method illustrated in the specification.

The one or more memory and/or storage units 120 are configured to store firmware and/or software, one or more operating systems, data and metadata required to the execution of any of the methods mentioned in this application.

FIGS. 1B and/or FIG. 1C illustrates the one or more memory and/or storage units 120 as storing at least some of:
A. Obtained representative vector 184. An obtained representative vector may represent an item captured in an image.
B. A catalog sample representative vector 189.
C. Image-based representative vectors 188 generated based on items caught by images.
D. A set of catalog sample representative vectors 186. The set may be allocated per scenario or may scenario indifferent. The set may include the catalog sample representative vector 189.
E. Training dataset 181—which is used for training a classification neural network.
F. Training software 174 for training a classification neural network. When the training is executed outside the vehicle the training dataset 181 and the training software may not be stored in one or more memory and/or storage units 120.
G. Representative vector generation software 176 for generating representative vectors—being image-based representative vectors or catalog sample representative vectors.
H. Classification neural network software 178.
I. Operating system 194.
J. Other classification software 180.
K. Additional software 172 that may be used to perform any other functionality of the vehicle and/or of any of the other units illustrated in FIG. 1A.

According to an embodiment, the classification neural network software, once executed by a processor, implements a classification neural network. According to an embodiment, the classification neural network software includes the obtained representative vector generation software or consists essentially of the obtained representative vector generation software.

According to an embodiment, the classification neural network software or the other classification software include the new class representative vector generation software.

The vehicle computer 121 may be in communication with an engine control module, a transmission control module, a powertrain control module, and the like

The memory and/or storage units 120 was shown as storing software. Any reference to software should be applied mutatis mutandis to code and/or firmware and/or instructions and/or commands, and the like.

Processor 126 includes a plurality of processing units 126(1)-126(J), J is an integer that exceeds one. Any reference to one unit or item should be applied mutatis mutandis to multiple units or items. For example—any reference to processor should be applied mutatis mutandis to multiple processors, any reference to communication system 130 should be applied mutatis mutandis to multiple communication systems.

According to an embodiment, the one or more memory and/or storage units 120 includes one or more memory unit, each memory unit may include one or more memory banks.

According to an embodiment, the one or more memory and/or storage units 120 includes a volatile memory and/or a non-volatile memory. The one or more memory and/or storage units 120 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 130. Other communication elements may be provided.

FIG. 1A illustrates communication system 130 as being in communication with various processors and/or units and network 132.

The communication system 130 may include a bus. The represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 132 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 130) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 120 may be stored outside the vehicle. It should also be noted that the processor may evaluate signatures generated by a plurality of detectors.

According to an embodiment—an obtained representative vector of an existing class is classified with a confidence level. The confidence level may be binary (outlier or inlier) or non-binary—for example may be a percent; or score; or any level within a specified range; or any level out of two or more levels. The confidence level may be calculated in various manners—such as based on a distance between the obtained representative vector to other obtained representative vectors. According to an embodiment, a representative vector associated with a class is also associated with a cluster and may be located at a centroid of a cluster—or be located at any other point within the cluster.

According to an embodiment, the processor is configured to:
A. Produce, by executing a classification neural network software associated with a driving of a vehicle, a catalog sample representative vector representing a catalog sample of a new class for autonomous driving being unidentified by the classification neural network at the time of the driving.
B. Generate, by executing the classification neural network software, a new image based representative vector representing an image of an entity of the new class.
C. Classify the entity as being associated with the new class. The classifying may be performed by executing the classification neural network software or a classification unit software.
D. Dynamically update a set of catalog sample representative vectors, and absent weights amendments of the classification neural network. The set may be allocated to a scenario being faced by the vehicle. The latter is required to identify the scenario.
E. Identify a scenario or receive an indication about the scenario.

FIG. 1D is an example of a computerized system 1000 that is not included within a vehicle. Computerized system 1000 is in communication with network 132 and one or more other remote computerized systems.

Computerized system 1000 includes sensing system 110, communication system 130, one or more memory and/or storage units 120, and processing system 124 including processor 126. The computerized system may be a server, a laptop, a desktop or any other computer and may include or be in communication with a sensing unit and/or a controller.

According to an embodiment, the memory and/or storage units 120 stores at least one of: operating system 194, software 193, additional software, information and metadata. Examples of information and/or metadata and/or software or additional software include obtained representative vector 184, new class representative vector 186, existing class representative vector 188, obtained representative vector generation software 174, new class representative vector generation software 176, and classification neural network software 178.

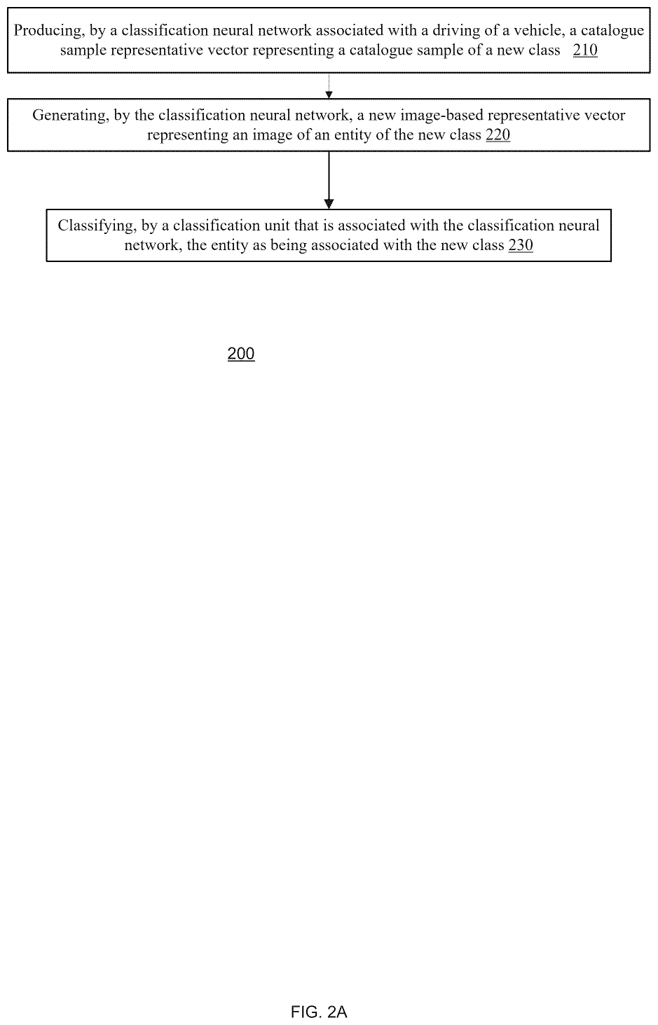

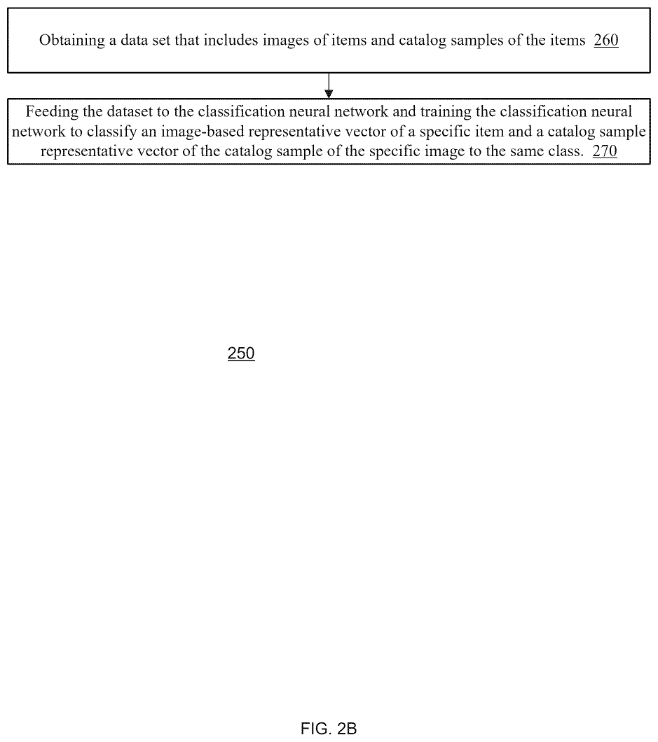

FIG. 2A illustrates an example of method 201 for dynamic classification for autonomous driving.

According to an embodiment, method 201 includes step 211 of producing, by a classification neural network associated with a driving of a vehicle, a catalog sample representative vector representing a catalog sample of a new class for autonomous driving being unidentified by the classification neural network at the time of the driving.

The catalog sample is identified by the classification neural network in the sense that the classification neural network was not trained to identify the catalog sample—and especially that one or more weights of the classification neural network were not amended during a training session to facilitate the identifying of the catalog sample.

According to an embodiment, step 211 is followed by step 221 of generating, by the classification neural network, a new image-based representative vector representing an image of an entity of the new class.

According to an embodiment, step 221 is followed by step 231 of classifying, by a classification unit that is associated with the classification neural network, the entity as being associated with the new class.

According to an embodiment, method 201 also includes step 225 of dynamically updating a set of catalog sample representative vectors, and absent weights amendments of the classification neural network. Additionally, or alternatively, method 201 includes dynamically updating a set of catalog representative vectors associated with a scenario being faced by the vehicle. The latter is required to identify the scenario. The identification of the scenario may be included in method 201. Alternatively, method 201 includes receiving an indication about the scenario.

According to an embodiment, the classification neural network is trained by a training process that comprises clustering image-based representative vectors of a given class based on distances between the image-based representative vectors of the given class and a catalog sample representative vector representing a catalog sample of the given class.

According to an embodiment, the training process includes applying, for the given class, a loss process that is operative to reduce a distance between image-based representative vectors of the given class and a catalog sample representing vector of the given class and increase the distance between the image-based representative vectors of the given class and other catalog sample representative vectors of other classes.

According to an embodiment, the training process includes applying, for the given class, a loss process that is operative to reduce an angle between image-based representative vectors of the given class and a catalog sample representing vector of the given class and increase the angle between the image-based representative vectors of the given class and other catalog sample representative vectors of other classes.

According to an embodiment, the training process involves applying a triple loss process.

According to an embodiment, step 211 includes performing a one-shot learning process.

According to an embodiment, step 211 includes performing a few-shot learning process.

One-shot learning and few-shot learning are techniques used in machine learning and computer vision to address the challenge of training models with limited labeled data. These approaches aim to enable the classification of new classes or objects with only a small number of examples, or even just a single example.

One-shot learning refers to the ability of a model to recognize and classify new objects or classes based on a single example. Traditional machine learning algorithms typically require a large amount of labeled data to train a model effectively. However, in real-world scenarios, obtaining a large number of labeled examples for every possible class or object may be impractical or time-consuming. One-shot learning techniques aim to overcome this limitation by leveraging the similarities and differences between classes to generalize from a single example.

To achieve one-shot learning, models often employ techniques such as metric learning, where the model learns to measure the similarity between examples. By comparing the features extracted from the single example to a set of known examples, the model can make predictions about the class or category of the new object. This approach relies on the assumption that objects from the same class will have similar features or characteristics.

Few-shot learning extends the concept of one-shot learning by allowing models to classify new classes or objects with a small number of examples, typically ranging from a few to a few dozen. This approach recognizes that while obtaining a single example may be challenging, acquiring a small number of examples for each class is more feasible in many cases.

In few-shot learning, models are trained to learn from a limited number of labeled examples per class. This involves leveraging transfer learning techniques, where knowledge gained from training on a large dataset is transferred to the few-shot learning task. The model learns to generalize from the limited examples by capturing the underlying patterns and similarities between classes.

To improve few-shot learning performance, various techniques have been developed, including meta-learning and episodic training. Meta-learning involves training a model on multiple few shot learning tasks, allowing it to learn how to learn from limited examples effectively. Episodic training involves creating episodes or mini batches during training, where each episode consists of a few examples from different classes. This helps the model learn to generalize across classes and adapt to new classes with limited examples.

Both one-shot learning and few-shot learning have significant implications in various domains, including computer vision, natural language processing, and robotics. These techniques enable models to quickly adapt to new classes or objects, making them more flexible and applicable in real-world scenarios where labeled data may be scarce or expensive to obtain.

Accordingly, one-shot learning and few-shot learning techniques provide solutions to the challenge of training models with limited labeled data. By leveraging similarities and patterns between classes, these approaches enable models to classify new objects or classes with only a single or a few examples. These techniques have the potential to revolutionize machine learning applications by enabling models to learn and adapt quickly to new information, even in data-scarce environments.

According to an embodiment, step 221 includes processing an image of the entity of the new class that is a cropped image of the entity of the new class.

According to an embodiment, the new representative vector is generated based on a cropped sensed information unit. Method for generating embedding information units based on cropped images is illustrated in U.S. patent application Ser. No. 18/595,368 filing date Mar. 3, 2024 which is incorporated herein by reference. Embedding information units such as embeddings and/or signatures of embeddings are examples of representative vectors.

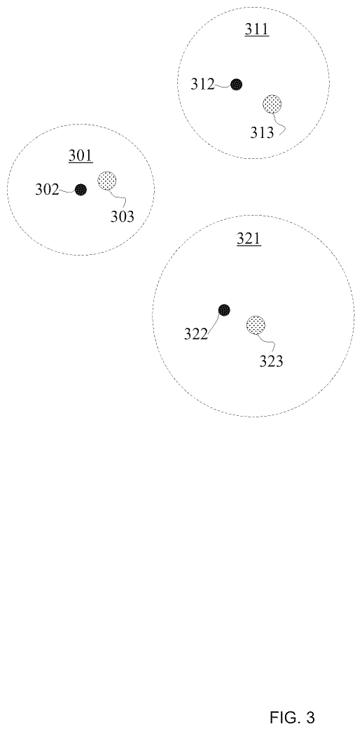

FIG. 3B is an example of a method 250 for training a classification neural network.

According to an embodiment, method 250 includes step 260 of obtaining a data set that includes images of items and catalog samples of the items.

According to an embodiment, the images of the items are tagged as being images of the items and the catalog samples of the items are tagged as being catalog samples of the items.

According to an embodiment, a catalog sample of an item is associated with one or more images of the item. The association may be provided with or without information about the item itself. The association may include storing together the catalog sample of a specific item and the one or more images of the specific item—and a unique location not shared by sample catalogs of other items.

According to an embodiment, step 260 is followed by step 270 of feeding the dataset to the classification neural network and training the classification neural network to classify an image-based representative vector of a specific item and a catalog sample representative vector of the catalog sample of the specific image to the same class—while classifying an image-based representative vector of another item and a catalog sample representative vector of the catalog sample of the other item to another class.

According to an embodiment, step 270 includes at least one of:
A. Generating for each class a unique cluster that includes one or more image-based representative vectors of an item of the class and a catalog sample representative vector. The clusters should not overlap.
B. Clustering image-based representative vectors of a given class based on distances between the image-based representative vectors of the given class and a catalog sample representative vector representing a catalog sample of the given class.
C. Applying, for the given class, a loss process that is operative to reduce a distance between image-based representative vectors of the given class and a catalog sample representing vector of the given class and increase the distance between the image-based representative vectors of the given class and other catalog sample representative vectors of other classes.
D. Applying, for the given class, a loss process that is operative to reduce an angle between image-based representative vectors of the given class and a catalog sample representing vector of the given class and increase the angle between the image-based representative vectors of the given class and other catalog sample representative vectors of other classes.

According to an embodiment, the training process involves applying a triple loss process. A triple loss uses three samples—an anchor sample, a positive sample (which is another sample of the same class), and a negative sample, which is a sample from another class. According to an embodiment, the positive sample is replaced by a catalogue sample of the anchor sample.

Any other loss processes may be applied.

FIG. 3 illustrates examples of clusters.

The first cluster 301 is associated with a first class and includes a first catalog sample representing vector 302 and a first image-based representative vector 303.

The second cluster 311 is associated with a second class and includes a second catalog sample representing vector 312 and a second image-based representative vector 313.

The third cluster 321 is associated with a third class and includes a third catalog sample representing vector 322 and a third image-based representative vector 323.

During classification, any representative vector that falls in a cluster is deemed to represent an item of a class associated with the cluster.

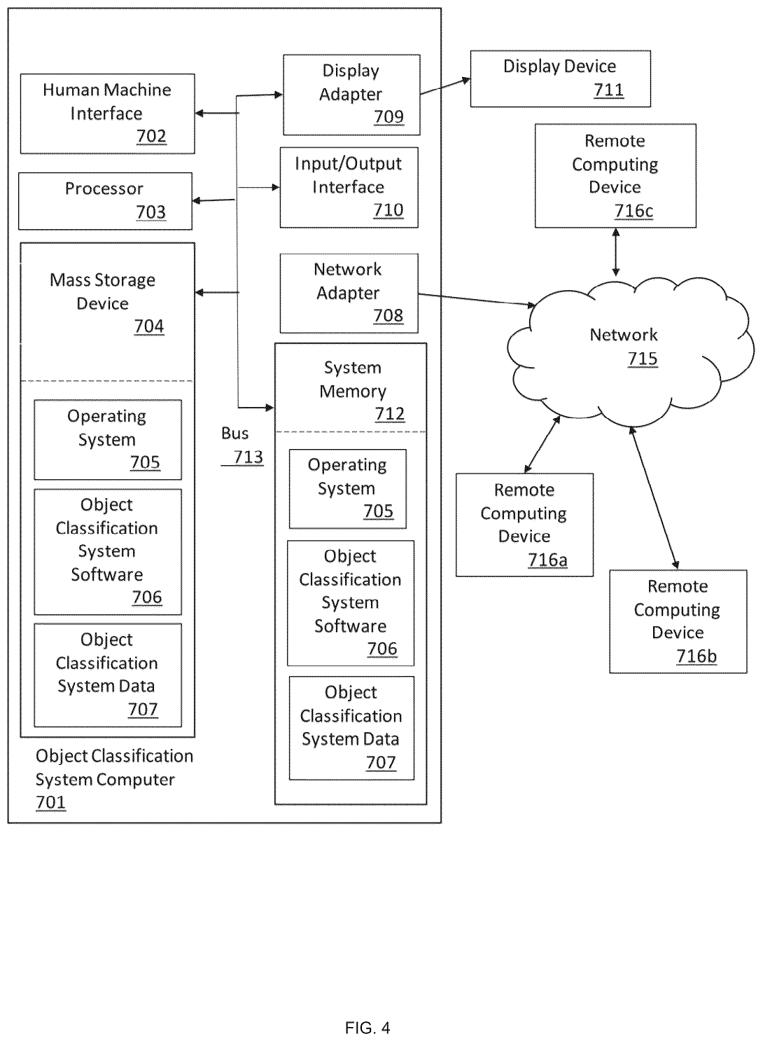

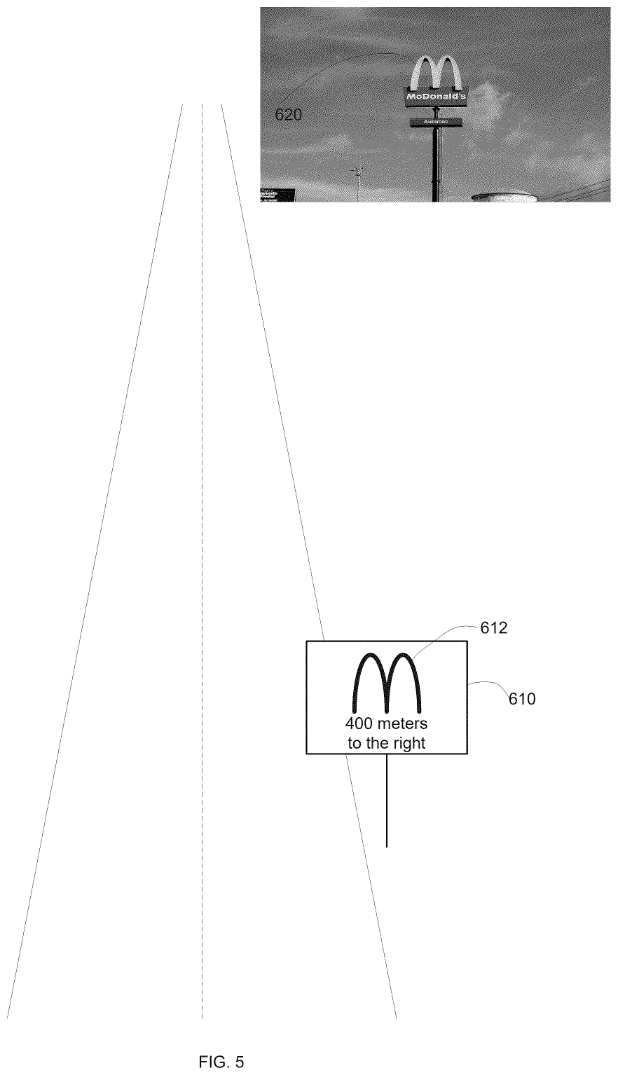

FIG. 4 is a block diagram illustrating an exemplary operating environment for performing at least a portion of disclosed methods according to an embodiment of the present invention. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

Further, one skilled in the art will appreciate that the systems and methods disclosed herein can utilize a specialized computing device in the form of an object classification system computer 701 (which may be included in, for example object classification system 100). The methods discussed above can be performed by the computer 701. For example, the computer 701 can perform the duties and responsibilities discussed above.

The components of the object classification system computer 701 can comprise, but are not limited to, one or more processors or processing units 703, a system memory 712, and a system bus 713 that couples various system components including the processor 703 to the system memory 712. In the case of multiple processing units 703, the system can utilize parallel computing.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, object classification system software 706, object classification system data 707, a network adapter 708, system memory 712, an Input/Output Interface 710, a display adapter 709, a display device 711, and a human machine interface 702, can be contained within one or more remote computing devices 714 a,b,c at physically separate locations, connected through buses of this form, in effect implementing a fully distributed system.

The object classification system computer 701 typically comprises a variety of computer readable media. Exemplary readable media can be any available media that is accessible by the object classification system computer 701 and comprises, for example and not meant to be limiting, both volatile and non-volatile media, removable and non-removable media. The system memory 712 comprises computer readable media in the form of volatile memory, such as random-access memory (RAM), and/or non-volatile memory, such as read only memory (ROM). The system memory 712 typically contains data such as object classification system data 707 and/or program modules such as operating system 705 and object classification system software 706 (i.e., modules and the like that perform the methods discussed above) that are immediately accessible to and/or are presently operated on by the processing unit 703.

In another aspect, the object classification system computer 701 can also comprise other removable/non-removable, volatile/non-volatile computer storage media. By way of example, FIG. 4 illustrates a mass storage device 704, which can provide non-volatile storage of computer code, computer readable instructions, data structures, program modules, and other data for the object classification system computer 701. For example, and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and object classification system software 706. Each of the operating system 705 and object classification system software 706 (or some combination thereof) can comprise elements of the programming and the object classification system software 706. object classification system data 707 can also be stored on the mass storage device 704. object classification system data 707 can be stored in any of one or more databases known in the art. Examples of such databases include DB2®, Microsoft® Access, Microsoft® SQL Server, Oracle®, mySQL, PostgreSQL, and the like. The databases can be centralized or distributed across multiple systems. In other aspects, the object classification system data 707 can be stored on the mass storage device 705 of other servers or devices (e.g., remote computing device 714 a,b,c,) in communication with the object classification system computer 701.

In another aspect, the user can enter commands and information into the object classification system computer 701 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 703 via a human machine interface 702 that is coupled to the system bus 713 but can be connected by other interface and bus structures, such as a parallel port, game port, an IEEE 1394 Port (also known as a Firewire port), a serial port, or a universal serial bus (USB).

In yet another aspect, a display device 711 can also be connected to the system bus 713 via an interface, such as a display adapter 709. It is contemplated that the object classification system computer 701 can have more than one display adapter 709 and more than one display device 711. For example, a display device can be a monitor, an LCD (Liquid Crystal Display), or a projector. In addition to the display device 711, other output peripheral devices can comprise components such as speakers (not shown) and a printer (not shown) which can be connected to the computer 701 via Input/Output Interface 710. Any step and/or result of the methods can be output in any form to an output device. Such output can be any form of visual representation, including, but not limited to, textual, graphical, animation, audio, tactile, and the like.

The object classification system computer 701 can operate in a networked environment using logical connections to one or more remote computing devices 714 a, b, c. By way of example, a remote computing device can be a personal computer, a laptop computer, portable computer, a server, a router, a network computer, a peer device or other common network node, and so on. Logical connections between the object classification system computer 701 and a remote computing device 714 a, b, c can be made via a local area network (LAN) and a general wide area network (WAN). Such network connections can be through a network adapter 708. A network adapter 708 can be implemented in both wired and wireless environments. Such networking environments are conventional and commonplace in offices, enterprise-wide computer networks, intranets, and a network 715 such as the internet 715.

For purposes of illustration, application programs and other executable program components such as the operating system 705 are illustrated herein as discrete blocks, although it is recognized that such programs and components reside at various times in different storage components of the object classification system computer 701 and are executed by the data processor(s) of the computer. An implementation of object classification system software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

According to an embodiment, object classification system computer 701 is configured to execute any method illustrated in the application.

According to an embodiment the object classification system computer 701 is in communication with one or more sensors of one or more types that are associated with the vehicle.

According to an embodiment the object classification system computer 701 is in communication with other vehicle computes such as control computers that are configured to control one or more vehicle units such as an engine controlling computer, a powertrain controlling computer, and/or with an autonomous driving unit configured to control autonomous driving, an ADAS unit configured to control ADAS operations, a path unit configured to navigate the vehicle, and the like. Each unit includes a processing circuit and/or stores in a non-transitory computer readable medium software and/or firmware and/or code and/or instructions for fulfilling the role of the unit.

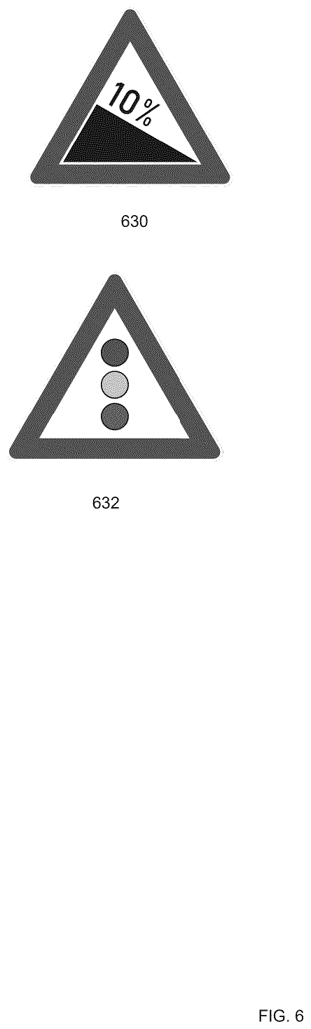

FIGS. 6 and 7 illustrates examples of catalog samples such as catalog samples 630 and 632 of road signs that were distributed to the public, and a road sign 610 (caught by an image of a vehicle) that indicates that the driver should see the golden arches (the road sign includes a sketch 612 of the golden arches) of MCDONALDS of a MCDONALDS branch located 400 meters away to the right.

Any combination of any step of any method illustrated in the application is provided.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle—such as a ground transportation vehicle, an airborne vehicle, or a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a spanning element. A spanning element may be implemented in software or hardware. Different spanning element of a certain iteration are configured to apply different mathematical functions on the input they receive. Non-limiting examples of the mathematical functions include filtering, although other functions may be applied.

The specification and/or drawings may refer to a concept structure. A concept structure may include one or more clusters. Each cluster may include signatures and related metadata. Each reference to one or more clusters may be applicable to a reference to a concept structure.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

A scenario may be a singular location/combination of properties at a point in time. A scenario is a series of events that follow logically within a causal frame of reference. Any reference to a scenario should be applied mutatis mutandis to a scenario.

The sensed information unit may be sensed by one or more sensors of one or more types. The one or more sensors may belong to the same device or system—or may belong to different devices of systems.

A perception unit may be provided and may be preceded by the one or more sensors and/or by one or more interfaces from receiving one or more sensed information units. The perception unit may be configured to receive a sensed information unit from an I/O interface and/or from a sensor. The perception unit may be followed by multiple narrow AI agents—also referred to as an ensemble of narrow AI agents.

A sensed information unit may or may not be processed before reaching the perception unit. Any processing may be providing—filtering, noise reduction, and the like.

We claim:

1. A method of dynamic classification for autonomous driving, the method comprises:
producing, by a classification neural network associated with a driving of a vehicle, a catalog sample representative vector representing a catalog sample of a new class for autonomous driving being unidentified by the classification neural network at the time of the driving;
generating, by the classification neural network, a new image-based representative vector representing an image of an entity of the new class; and
classifying, by a classification unit that is associated with the classification neural network, the entity as being associated with the new class.

2. The method according to claim 1, comprising dynamically updating a set of catalog representative vectors, and absent weights amendments of the classification neural network.

3. The method according to claim 2, comprising dynamically updating a set of catalog representative vectors associated with a scenario being faced by the vehicle.

4. The method according to claim 1, wherein the classification neural network is trained by a training process that comprises clustering image-based representative vectors of a given class based on distances between the image-based representative vectors of the given class and a catalog sample representative vector representing a catalog sample of the given class.

5. The method according to claim 4, wherein the training process comprises applying, for the given class, a loss process that is operative to reduce a distance between image-based representative vectors of the given class and a catalog sample representing vector of the given class and increase the distance between the image-based representative vectors of the given class and other catalog sample representative vectors of other classes.

6. The method according to claim 4, wherein the training process comprises applying, for the given class, a loss process that is operative to reduce an angle between image-based representative vectors of the given class and a catalog sample representing vector of the given class and increase the angle between the image-based representative vectors of the given class and other catalog sample representative vectors of other classes.

7. The method according to claim 4, wherein the training process involves applying a triple loss process.

8. The method according to claim 1, wherein the producing comprises performing a one-shot learning process.

9. The method according to claim 1, wherein the producing comprises performing a few-shot learning process.

10. The method according to claim 1, wherein the image of the entity of the new class is a cropped image of the entity of the new class.

11. A non-transitory computer readable medium for dynamic classification for autonomous driving, the non-transitory computer readable medium stores instructions for:
producing, by a classification neural network associated with a driving of a vehicle, a catalog sample representative vector representing a catalog sample of a new class for autonomous driving being unidentified by the classification neural network at the time of the driving;
generating, by the classification neural network, a new image-based representative vector representing an image of an entity of the new class; and
classifying, by a classification unit that is associated with the classification neural network, the entity as being associated with the new class.

12. The non-transitory computer readable medium according to claim 11, that stores instructions for dynamically updating a set of catalog representative vectors, and absent weights amendments of the classification neural network.

13. The non-transitory computer readable medium according to claim 12, that stores instructions for dynamically updating a set of catalog representative vectors associated with a scenario being faced by the vehicle.

14. The non-transitory computer readable medium according to claim 11, wherein the classification neural network is trained by a training process that comprises clustering image-based representative vectors of a given class based on distances between the image-based representative vectors of the given class and a catalog sample representative vector representing a catalog sample of the given class.

15. The non-transitory computer readable medium according to claim 14, wherein the training process comprises applying, for the given class, a loss process that is operative to reduce a distance between image-based representative vectors of the given class and a catalog sample representing vector of the given class and increase the distance between the image-based representative vectors of the given class and other catalog sample representative vectors of other classes.

16. The non-transitory computer readable medium according to claim 14, wherein the training process comprises applying, for the given class, a loss process that is operative to reduce an angle between image-based representative vectors of the given class and a catalog sample representing vector of the given class and increase the angle between the image-based representative vectors of the given class and other catalog sample representative vectors of other classes.

17. The non-transitory computer readable medium according to claim 14, wherein the training process involves applying a triple loss process.

18. The non-transitory computer readable medium according to claim 11, wherein the producing comprises performing a one-shot learning process.

19. The non-transitory computer readable medium according to claim 11, wherein the producing comprises performing a few-shot learning process.

20. The non-transitory computer readable medium according to claim 11, wherein the image of the entity of the new class is a cropped image of the entity of the new class.
